(19) United States
(12) Patent Application Publication
(10) Pub. No.: US 2004/0224100 A1
(43) Pub. Date: Nov. 11, 2004

(54) Plasma-treated planar textile structures and method for the manufacture thereof

(75) Inventors: Brigit Severich, Mannheim (DE); Gerhard Schoepping, Hemsbach (DE); Wolfgang Hallstein, Fuerth (DE); Stephan Rutz, Weinheim (DE); Peter Kritzer, Forst (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 10/831,062

(22) Filed: Apr. 23, 2004

(30) Foreign Application Priority Data
Apr. 25, 2003 (DE) DE 103 19 057.0-4

(51) Int. Cl. H05H 1/24; H01M 2/16

(52) U.S. Cl. 427/535; 427/569; 429/249

(57) ABSTRACT

A plasma-treated planar textile structure containing synthetic fibers and a method for manufacturing the structure, wherein the structure has a high initial wettability, expressed by a height of rise of at least 80 mm after immersion for 30 minutes in an aqueous potassium hydroxide solution, and, upon storage for three months in air at 25° C., has a high initial wettability, expressed by a height of rise of at least 75 mm after immersion for 30 minutes in an aqueous potassium hydroxide solution. The plasma-treated planar textile structures preferably have a high hydrophilic stability when stored in alkaline media. The plasma-treated planar textile structures can be used, in particular, as separators for electrochemical energy storage devices.

Priority is claimed to German Patent Application No. DE 103 19 057.0, filed on Apr. 25, 2003, the entire disclosure of which is incorporated by reference herein.

The present invention relates to plasma-treated planar textile structures, in particular nonwoven fabrics, which are permanently hydrophilized, their manufacture, and their use as separators for electrochemical cells, in particular, as separators for rechargeable alkaline batteries.

### BACKGROUND

Electrochemical energy storage devices, such as alkaline batteries or cells, must be provided with separators that separate the two differently charged electrodes in the energy storage device, thus preventing an internal short-circuit. A number of characteristics are desired for separator materials, which can be summarized as follows:

1. resistance to the electrolyte;

2. resistance to oxidation;

3. high mechanical stability;

4. low weight and thickness tolerances;

5. low resistance to the passage of ions;

6. high resistance to the passage of electrons;

7. retention capacity for solid particles coming off the electrodes;

8. immediate spontaneous wettability by the electrolyte (generally within periods smaller than 10 s);

9. permanent wettability by the electrolyte; and

10. high storage capacity for the electrolyte liquid.

Planar textile structures, in particular nonwoven fabrics of synthetic fibers, are, in principle, well-suited as separator materials because of their good resistance to electrolyte liquids and, at the same time, their high flexibility.

However, depending on the polymer used for the manufacture of the separator, the corresponding separator materials have different advantages and disadvantages.

Thus, for example, separators made of polyolefins have a very good resistance to chemical attack by strongly alkaline electrolytes and to oxidation in the chemical environment of the cells; however, the wettability by the alkaline electrolyte is poor. In contrast, polyamide can always be wetted sufficiently well, but its resistance to hydrolysis by alkaline electrolytes is not sufficient, especially at elevated temperatures.

Nonwoven fabrics made of many different materials have already been proposed as separator materials. Also known are many different treatment methods for reducing or avoiding the disadvantages of individual separator materials.

Thus, alkaline battery separators made of polyamide and/or polyolefins are described, for example, in documents DE-A-2,164,901, DE-A-1,142,924, DE-A-2,203,167, and DE-A-2,438,531.

When using hydrophobic fibers, serious disadvantages arise in many cases because the fibers do not have the required electrolyte absorption capacity and the required retention capacity for the electrolyte liquid.

Different methods have already been proposed to increase the wettability of polyolefin fibers.

Thus, for example, separator materials have been provided with a hydrophilic finish, as, for example, in documents U.S. Pat. No. 3,947,537, DE-A-2,542,089, or DE-A-2,542,064. This approach involves the risk that the electrolyte liquid is contaminated by the wetting agents usually used, or by the hydrophilic substances which, partly, are added directly to the hydrophobic polymer, and that the life of the accumulator is thereby shortened. Therefore, nonwoven fabrics with such a finish, are only conditionally suitable as battery separators because the sensitive system of the electrochemical energy storage devices is disturbed by the introduction of the additional chemicals. Therefore, it is preferable to design the separators only of accurately defined fibrous materials, and to use only those hydrophilic additives that will not cause any failures during the operation of the energy storage device.

In order to make polyolefin fibers hydrophilic, it has been proposed to fluorinate these fibers, as described, for example, in documents JP-A-2/276,154 and DE-A-195 23 231. The electrolyte absorption capacity and permanent wettability with electrolyte solution of separators that are treated in this manner meet the demands placed on them; however, these fluorinated nonwoven fabrics are only conditionally suitable battery separators because they do not provide spontaneous wetting with electrolyte liquid. This poor initial wettability leads to faults in the manufacture of the cells, because the proportioned amount of electrolyte cannot be absorbed by the separator and distributed in the interior of the cell fast enough, which will result in electrolyte spills during the subsequent addition of electrolyte, and thus in contamination of the production.

Permanent wetting with a high degree of initial wetting and without a decrease in hydrophilicity due to storage under ambient conditions can be achieved by wet chemical methods. A method for surface modification of polyolefins by wet-chemically grafting a vinyl monomer thereon is known from document EP-A-593,612. The treated planar textile structures have polyolefin fibers, onto the surface of which were grafted special vinyl monomers, and which have obtained an ion exchange capacity as a result of this modification.

Furthermore, it is known from document EP-A-316,916 to modify the surface of polyolefin separators by sulfonation with oleum. Wet-chemical surface treatment methods are problematic in terms of workplace safety and ecological requirements because of the solvent vapor emissions and wastewater contamination. Due to the high expenditure of energy and time for the drying processes, the costs of these methods are relatively high.

Plasma-based methods for hydrophilizing planar textile structures have already been proposed as well.

Until now, permanent hydrophilization without using chemicals is known only in low-pressure plasma. Corresponding methods that work at negative pressure are described in documents DE-A-3,116,738, DE-A-100 37 048 and EP-A-999,602. Nothing is known about the long-term hydrophilic stability of the treated materials.

In the textile industry, plasma-based methods working at atmospheric pressure (such as corona discharge) are increasingly gaining importance because here, unlike the classical low-pressure plasma, complex vacuum technology can be dispensed with. This reduces both plant and process costs.

Thus, for example, documents JP-A-2001/068,087, JP-A-05/295,662, JP-A-01/072,459, JP-A-08/311,765, JP-A-2000/208,124, JP-A-2000/215,874, EP-A-937,811 and DE-A-197 31 562 describe methods for treating planar textile structures or porous materials by electric discharge at atmospheric pressure; in all cases, however, a chemical working gas, such as SO₂, NO₂, acetone, fluorinated hydrocarbon, azo compounds, or peroxides being supplied to the discharge.

According to document JP-A-11/354,093, to achieve permanent and fast wettability of battery separators, a corona discharge is used before or after impregnation with a surfactant.

According to documents JP-A-05/006,760, JP-A-12/123,814 and JP-A-11/354,093, to achieve permanent and fast wettability of battery separators, a corona discharge is used before or after classical wet-chemical sulfonation, or after treatment with potassium hydroxide solution.

Document DE-A-4,235,766 describes the treatment of materials by corona discharge.

Further methods and devices for plasma treatment of substrates are known from documents DE-A-41 00 787, WO-A-00/10,703, WO-A-94/28,568, EP-A-937,811 and DE-A-197 31 562. The latter document describes the use of a barrier discharge with air as the working gas.

Document DE-A-100 17 680 also proposes to treat a running length of textile material with electric charge carriers on at least one surface. This method also uses a plasma barrier discharge.

### SUMMARY OF THE INVENTION

It has been found that planar textile structures can be given a desired combination of properties by treatment with a plasma produced by a special corona generator, resulting in products that are particularly suitable for use as separators.

An object of the present invention provides products characterized by a high initial wettability and by permanent hydrophilicity.

The present invention provides a hydrophilic planar textile structure which can preferably be used as a separator, and which is characterized by a high and fast electrolyte absorption capacity (initial wettability) as well as a high stability of the initial wettability upon storage of the treated planar textile structures under ambient conditions. Furthermore, the products according to the present invention have a high electrolyte retention capacity.

It is a further or alternate object of the present invention to a provide planar textile structure that can be used as a separator without its use allowing foreign matter, such as surfactants, to enter the electrolyte liquid, thus shortening the life of the energy storage device.

It is yet another further or alternate object of the present invention to provide a planar textile structure whose wetting properties do not change, or change only insignificantly, when stored in alkaline media such as potassium hydroxide solution.

A another further or alternate object of the present invention is to provide a plasma-treated planar textile structures whose wetting properties virtually do not change when stored over long periods of time.

It is yet another further or alternate object of the present invention to provide an environmentally friendly and cost-effective method without using chemicals and without wastewater contamination.

The present invention provides a method of treating a planar textile structure using a selected plasma-based surface modification at atmospheric pressure with air as the process gas.

The present invention provides hydrophilized planar textile structures having a high initial wettability and wetting properties that are stable over long periods of time. These properties can be characterized by determining the height of rise of an aqueous potassium hydroxide solution.

The present invention relates to plasma-treated planar textile structures containing synthetic fibers, which have a high initial wettability, expressed by a height of rise of at least 80 mm, preferably at least 90 mm, after immersion for 30 minutes in an aqueous potassium hydroxide solution, and which, upon storage for three months, preferably six months, in air at 25° C., have a high initial wettability, expressed by a height of rise of at least 75 mm, preferably at least 85 mm, after immersion for 30 minutes in an aqueous potassium hydroxide solution.

The plasma-treated planar textile structures according to the present invention preferably have an excellent stability of the wetting properties when stored in alkaline media, expressed as a height of rise of at least 20 mm, preferably at least 35 mm, after immersion for 30 minutes in an alkaline medium upon storage in an aqueous potassium hydroxide solution for one week at 25° C. These properties are determined in a standardized planar textile structure using the method described further below.

The planar textile structures according to the present invention can be produced in any way. All techniques for forming planar structures can be used, such as weaving, laying, spring-needle knitting, latch-needle knitting, or wet-laid or dry-laid nonwoven manufacturing processes.

Besides planar textile structures made of staple fibers and/or filament yarns, spunbonded nonwoven fabrics made of continuous filaments are possible as well.

Within the scope of this specification, “planar textile structures” are understood to be woven fabrics, latch-needle knit fabrics, spring-needle knit fabrics, scrims, or, in particular, porous films or nonwoven fabrics.

The planar textile structures according to the present invention contain fibers of synthetic polymers, and are preferably bonded together.

The planar textile structures according to the present invention can be can be composed of any fiber types of the most different diameter ranges. Typical fiber diameters range from 0.01 to 200 μm, preferably from 0.05 to 50 μm.

Besides continuous filaments, these planar textile structures can also be composed of or contain staple fibers.

Besides homofil fibers, it is also possible to use heterofil fibers, or mixtures of the most different fiber types.

The planar textile structures according to the present invention can be produced using any wet or dry process known per se. For example, in the case of the nonwoven fabrics, it is possible to use spunbonding processes, carding processes, melt-blowing process, wet-laid process, electrostatic spinning, or aerodynamic methods for manufacturing nonwoven fabrics.

Typically, the planar textile structures according to the present invention, in particular the nonwoven fabrics, have a weight per unit area of 0.05 to 500 g/m².

It is particularly preferred to use nonwoven fabrics having a low weight per unit area of 5 to 150 g/m².

Depending on the intended use, the most different polymers can be used as synthetic polymers.

Thus, for example, in batteries containing acidic electrolytes, it is preferred to use polyolefins, in particular polypropylene (“PP”) or polyethylene (“PE”), graft or copolymers of polyolefins and α,β-unsaturated carboxylic acids or acid anhydrides, polyester, polycarbonate, polysulfone, polyphenylene sulfide, polystyrene, or blends thereof.

In accumulators containing alkaline electrolytes, it is preferred to use polyamides, polyolefins, in particular polypropylene (“PP”) or polyethylene (“PE”), copolymers of polyolefins and α,β-unsaturated carboxylic acids or acid anhydrides, polysulfone, polyphenylene sulfide, polystyrene, or blends thereof.

It is particularly preferred to use planar textile structures made of polyolefin fibers, in particular of polypropylene fibers and/or polypropylene/polyethyelene bicomponent fibers, in particular core/sheath fibers having a PP core and a PE sheath. In addition to a reasonable price, these products feature high resistance to chemically aggressive environments. They are preferably suitable for use as separators for energy storage devices containing alkaline electrolytes.

The planar textile structures according to the present invention can be bonded together in a manner known per se, for example, by mechanical or hydraulic needling, or by filsing binder fibers that are present in the planar textile structure.

It has been found that the products according to the present invention can be produced by a special plasma treatment, and that similar treatment methods do not lead to products having the described property profile, in particular not to products that exhibit long-term hydrophilic stability.

According to the present invention, a corona generator may be used that is of the type described in document DE-A-42 35 766, the entire disclosure of which is incorporated by reference herein.

Corona generators are generators for generating voltage pulses which are applied to the primary winding of a high-voltage transformer and, via the secondary winding thereof, produce a corona discharge between a corona electrode and a counter-electrode. The generator used according to the present invention is characterized in that it automatically adapts to the electrical properties of the materials to be treated, and in that it has a considerably simplified electronic circuit.

The corona generator used according to the present invention is powered from a DC source, and is essentially composed of a first resonant circuit, a switch, and a second resonant circuit having a high-voltage transformer associated therewith. The first resonant circuit is a series resonant circuit which includes an inductor and a capacitor, and which is connected to the primary winding of the high-voltage transformer via a switch, a diode and an inductor. The inductance of the inductor in the first resonant circuit (charging circuit) and the switching criterion of the switch in the second resonant circuit (discharge circuit), which is derived from the voltage in the capacitor, are selected such that the frequency of the voltage pulses occurring in the generator at the primary winding is smaller than the natural frequency of the damped secondary resonant circuit. A corona electrode and a grounded counter-electrode are used as the corona discharge path, the planar textile structure to be treated being passed over the counter-electrode. The corona electrode is provided with a dielectric coating, and is arranged at a small distance above the couter-electrode. Therefore, the discharge is of the type of a barrier discharge.

Thus, the present invention also relates to a method for manufacturing the above-described hydrophilized planar textile structures, including the steps of:

a) manufacturing the planar textile structure using a technique for forming planar textile structures in a manner known per se,

b) providing a region of space in which arcs a barrier discharge produced by corona generator,

c) conveying the planar textile structure through the region of space in which the barrier discharge arcs so that the planar textile structure is exposed to the barrier discharge,

d) the corona generator being essentially composed of a first resonant circuit, a switch, and a second resonant circuit having a high-voltage transformer associated therewith, the first resonant circuit being a series resonant circuit which includes an inductor and a capacitor, and which is connected to the primary winding of a high-voltage transformer via a switch, a diode and an inductor; and the inductance of the inductor in the first resonant circuit and the switching criterion of the switch in the second resonant circuit, which is derived from the voltage in the capacitor, being selected such that the frequency of the voltage pulses occurring in the generator at the primary winding is smaller than the natural frequency of the damped secondary resonant circuit.

It is particularly preferred that the transport of the planar textile structure through the corona discharge is carried out at atmospheric pressure, and that the corona discharge takes place in air without the addition of further gases or additives.

The plasma treatment is carried out by continuously passing the planar textile structure through the corona discharge. Typical line speeds are 0.5 to 400 m/min.

Usually, the treatment is carried out in air at atmospheric pressure. The treatment can also be carried out in a non-oxidizing atmosphere containing, for example, a noble gas, such as helium or argon, as the inert gas, or with the addition of reactive gases or additives in the plasma. Typical operating pressures in the plasma are 0.7 to 1.3 bar, preferably 0.9 to 1.1 bar.

The planar textile structures according to the present invention can be used, in particular, in the form of nonwoven fabrics in environments where chemically aggressive materials are present. An example of this is their use as filter materials or as separators in batteries, in particular, in batteries containing alkaline electrolytes. These uses also form part of the subject matter of the present invention.

### BRIEF DESCRIPTION OF THE DRAWINGS

The invention is described in more detail below. Reference is made to the drawing, in which:

FIG. 1 shows a schematic flow diagram of a method according to the present invention.

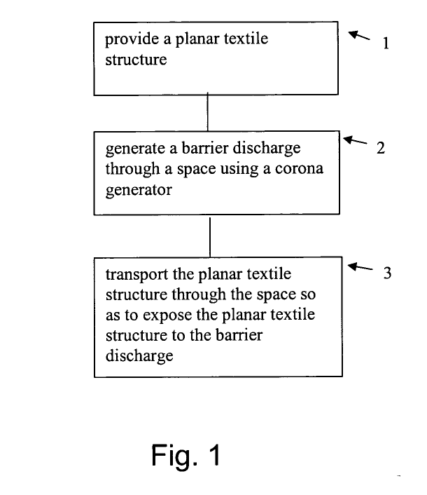

### DETAILED DESCRIPTION

The following examples illustrate the present invention without limiting it.

General Procedure

In a first step, in a method for manufacturing a hydrophilized planar textile structure, a planar structure is provided. Block 1. The planar textile structure may be provided, for example according to any known way. In a second step, a barrier discharge is generated through a space using a corona generator. Block 2. Preferably, the corona generator is of the type described in DE 42 35 766, as discussed above. The planar textile structure is transported through the space so as to expose the planar textile structure to the barrier discharge. Block 3.

For the following examples, polyolefin nonwoven fabrics made of core/sheath fibers having a PP core and a PE sheath were manufactured according to the wet-laid process.

These polyolefin nonwoven fabrics were fused together at the crossing points of the fibers in a dryer.

In a second step, the polyolefin nonwoven fabrics produced in this manner were passed through a corona discharge, in which process a corona generator according to document DE-A-42 35 766 was used.

Immediately after the corona treatment, the hydrophilicity of the obtained products was determined using the following method:

Determination of the rate of suction or height of rise in a standardized planar textile structure.

The rate of suction is the rate at which an electrolyte solution (30% KOH solution) is drawn up in the nonwoven fabric by capillary forces. In the process, the rate of rise of the solution in the nonwoven fabric is measured against gravity. The measure used is the height of rise in defined time periods.

Before the measurement, the nonwoven fabric samples having a width of 30 mm and a length of 250 mm were conditioned for 24 hours in a standard climate (65% air humidity, 20° C.). After that, the nonwoven fabric samples were fixed vertically above a pan containing 30% KOH solution, and lowered until about 10 mm of the nonwoven fabric were immersed in the electrolyte. The time measurement was started at the same time using a stopwatch.

The KOH solution rose in the nonwoven fabric sample and was read off as the height of rise in mm after a period of 30 minutes.

Instead of nonwoven fabric, it is also possible to use other types of planar textile structures according to the present invention.

Immediately after the corona treatment, the obtained products were stored for one week in 30% aqueous potassium hydroxide solution at 25° C., and, subsequently, the height of rise was determined according to the method described above.

The chemical resistance was determined by exposure to an electrolyte solution according to the method described below:

Nonwoven fabric samples having a width of 30 mm and a length of 250 mm were stored for one week in 30% potassium hydroxide solution at 70° C., subsequently washed to neutral pH with deionized water, and dried in a convection drying oven at 70° C. After that, the rate of suction or height of rise was determined according to the method described above.

In addition, after the corona treatment, the nonwoven fabrics were stored in air at 25° C. for three and six months, respectively. After that, the hydrophilicity of the stored products was determined according to the method described above.

### EXAMPLE 1

A nonwoven polyolefin fabric having a weight per unit area of 50 g/m² was treated at 1.2 m/min in an atmospheric pressure plasma according to the above procedure.

The hydrophilicity of the nonwoven fabric treated in this manner was characterized according to the measurement procedure described above immediately after the plasma treatment and after storage for one week in 30% aqueous KOH solution.

After 30 minutes, the height of rise of the KOH solution was observed to be 85 mm. After storing the nonwoven fabric in the KOH solution for one week, the height of rise was determined to be 35 mm.

After storing the plasma-treated nonwoven fabric in air at 25° C. for three and six months, respectively, no change in hydrophilicity could be found. After 30 minutes, the height of rise of the KOH solution was observed to be 85 mm.

### EXAMPLE 2

A nonwoven polyolefin fabric having a weight per unit area of 50 g/m was treated at 0.6 m/min in an atmospheric pressure plasma according to the above procedure.

The hydrophilicity of the nonwoven fabric treated in this manner was characterized according to the measurement procedure described above immediately after the plasma treatment and after storage for one week in 30% aqueous KOH solution.

After 30 minutes, the height of rise of the KOH solution was observed to be 90 mm. After storing the nonwoven fabric in the KOH solution for one week, the height of rise was determined to be 45 mm.

After storing the plasma-treated nonwoven fabric in air at 25° C. for three and six months, respectively, no change in hydrophilicity could be found. After 30 minutes, the height of rise of the KOH solution was observed to be 90 mm.

### EXAMPLE 3

A nonwoven polyolefin fabric having a weight per unit area of 60 g/m² was treated and characterized as described in Example 1.

After 30 minutes, the height of rise of the KOH solution was observed to be 90 mm. After storing the nonwoven fabric in the KOH solution for one week, the height of rise was determined to be 25 mm.

After storing the plasma-treated nonwoven fabric in air at 25° C. for three and six months, respectively, no change in hydrophilicity could be found. After 30 minutes, the height of rise of the KOH solution was observed to be 90 mm.

### EXAMPLE 4

A nonwoven polyolefin fabric having a weight per unit area of 60 g/m² was treated and characterized as described in Example 2.

After 30 minutes, the height of rise of the KOH solution was observed to be 102 mm. After storing the nonwoven fabric in the KOH solution for one week, the height of rise was determined to be 40 mm.

After storing the plasma-treated nonwoven fabric in air at 25° C. for three and six months, respectively, no change in hydrophilicity could be found. After 30 minutes, the height of rise of the KOH solution was observed to be 102 mm.

### EXAMPLE 5 (COMPARISON)

A nonwoven polyolefin fabric having a weight per unit area of 50 g/m² was treated at 1 m/min according to the above procedure and characterized as described above, however, using a conventional generator that does not follow the characteristic described above.

After 30 minutes, the height of rise of the KOH solution was observed to be 48 mm. After storing the nonwoven fabric in the KOH solution for one week, the height of rise was determined to be 0 mm.

After storing the plasma-treated nonwoven fabric in air at 25° C. for three months, the height of rise of the KOH solution was observed to be 85 mm after 30 minutes.

What is claimed is:

1. A plasma-treated planar textile structure comprising synthetic fibers, wherein the structure has a high initial wettability expressed by a height of rise of at least 80 mm after immersion for 30 minutes in an aqueous potassium hydroxide solution, wherein upon storage for three months in air at 25° C., the structure has a high initial wettability, expressed by a height of rise of at least 75 mm after immersion for 30 minutes in an aqueous potassium hydroxide solution.

2. The plasma-treated planar textile structure as recited in claim 1, wherein upon storage for six months in air at 25° C., the structure has a high initial wettability, expressed by a height of rise of at least 75 mm after immersion for 30 minutes in an aqueous potassium hydroxide solution.

3. The plasma-treated planar textile structure as recited in claim 1, wherein the structure is one of a nonwoven fabric and a porous film.

4. The plasma-treated planar textile structure as recited in claim 1, wherein the synthetic fibers include polyolefin fibers.

5. The plasma-treated planar textile structure as recited in claim 4, wherein the polyolefin fibers include at least one of polypropylene fibers and bicomponent fibers, wherein the bicomponent fibers are made of polypropylene and polyethylene.

6. The plasma-treated planar textile structure as recited in claim 4, wherein the structure exhibits a height of rise of at least 90 mm after immersion for 30 minutes in a potassium hydroxide solution, and exhibits a height of rise of at least 15 mm after storage for one week in the potassium hydroxide solution at 25° C.

7. A plurality of plasma-treated planar textile structures as recited in claim 1, wherein the planar textile structures are bonded together by fusing binder fibers.

8. A method for manufacturing a hydrophilized planar textile structure, comprising the steps of:
a) providing a planar textile structure;
b) generating a barrier discharge through a space using a corona generator; and
c) transporting the planar textile structure through the space so as to expose the planar textile structure to the barrier discharge.

9. The method as recited in claim 8, wherein the corona generator includes a first resonant circuit, a second resonant circuit and a high-voltage transformer, the first resonant circuit being a series resonant circuit that includes an inductor, a capacitor, a switch and a diode and is connected to a primary winding of the high-voltage transformer, wherein a switching criterion of the switch is derived from the voltage in the capacitor, the switching criterion and an inductance of the inductor being selected such that a frequency of voltage pulses occurring at the primary winding is smaller than a natural frequency of the secondary resonant circuit.

10. The method as recited in claim 8, wherein the planar textile structure has a high initial wettability expressed by a height of rise of at least 80 mm after immersion for 30 minutes in an aqueous potassium hydroxide solution, wherein upon storage for three months in air at 25° C., the structure has a high initial wettability, expressed by a height of rise of at least 75 mm after immersion for 30 minutes in an aqueous potassium hydroxide solution.

11. The method as recited in claim 8, wherein the transporting of the planar textile structure through the space is carried out at atmospheric pressure, and the generating of the barrier discharge in the space is performed in air.

12. An electrochemical cell comprising a separator cell that includes the plasma-treated planar textile structure as recited in claim 1.

13. The electrochemical cell as recited in claim 12, wherein the cell is a portion of at least one of a battery and an accumulator.

14. The electrochemical cell as recited in claim 13, wherein the battery is an alkaline battery and the accumulator is an alkaline accumulator.
